(19) United States
(12) Patent Application Publication
(10) Pub. No.: US 2018/0208362 A1
(43) Pub. Date: Jul. 26, 2018

(54) CUP APPARATUS

(71) Applicant: JOHN M. MAURELLO, OCEANSIDE, NY (US)

(72) Inventor: JOHN M. MAURELLO, OCEANSIDE, NY (US)

(21) Appl. No.: 15/880,823

(22) Filed: Jan. 26, 2018

Related U.S. Application Data
(60) Provisional application No. 62/450,938, filed on Jan. 26, 2017.

(51) Int. Cl. B65D 21/02

(52) U.S. Cl. CPC B65D 21/0233; A01K 7/00

(57) ABSTRACT

The invention features a cup apparatus, structurally configured to fit or be removably attached to the base of a water container such as a bottle. The cup apparatus may include a top or mouth, a plurality of interconnected ribs which connect the top with a base, and a lip. Aspects of embodiments of the present invention also contemplate the plurality of ribs being structurally configured to exert inward force towards the center of the apparatus. This force enables a snug fit between the surface of the ribs with the surface of the water container when the container is placed within the cup apparatus.

### CROSS-REFERENCE TO RELATED APPLICATIONS

This Application claims the benefit of, and is related to, Applicant's following provisional patent application: U.S. Provisional Patent Application No. 62/450,938 titled “PET CUP APPARATUS” filed Jan. 26, 2017, which is incorporated herein in its entirety.

### FIELD OF THE INVENTION

The present invention relates, in general, to a cup apparatus and, in particular, a cup apparatus designed to be removably attached to the base of a water container, such as a bottle.

### BACKGROUND OF THE INVENTION

People intent on sharing water from their bottle with either others or their pets face a dilemma: allow the other person or pet drink directly from the bottle or refuse to give the other person or pet water from their bottle. This predicament is enhanced by the risk of bacterial transfer or transfer of viruses by way of sharing the bottle with others. Pouring out the water into the other person's hands is inefficient and wasteful. Besides, this option is not available to pets who cannot form a cup with their appendages.

As such, there is a need for an apparatus that would enable the sharing of water from one's water container, such as a bottle. There is also a need for a portable container that could be transported easily with no hassles and no inconvenience. Further still, there is a need for a cup apparatus that can be discarded following use.

### SUMMARY OF THE INVENTION

An aspect of an embodiment of the present invention contemplates a cup apparatus which may include: a top portion or mouth, a base, a plurality of expandable ribs, where the ribs connect the top portion or mouth with the base, and a lip portion, where the tops of the plurality of expandable ribs contact the lip's base.

In an aspect of an embodiment of the present invention, where the mouth and the base are more or less circular in shape, the mouth of the apparatus may have a smaller radius than that of the base.

In an aspect of an embodiment of the present invention, the plurality of expandable ribs may be interconnected with each other. In another aspect of an embodiment of the present invention, the apparatus may include a cylindrical wall connecting the apparatus's base with its mouth. The cylindrical wall may then have a number of expandable ribs which extend from the base of the apparatus to the mouth of the apparatus. These ribs, in either aspect, enable a snug fit of the cup apparatus onto the base of a water container or bottle.

In an aspect of an embodiment of the present invention, the plurality of expandable ribs may be structurally configured to exert inward force at least at one point midway between the mouth and base of the apparatus. This inward force enables a snug fit of the cup apparatus onto the base of the water container or bottle. In one aspect of an embodiment of the present invention, the inward force may be exerted as a normal (i.e. perpendicular direction) from the surface of the rib(s) and onto the surface of the container.

In an aspect of an embodiment of the present invention, the inward force may be enabled by bulge(s) on one or more of the plurality of expandable ribs. This inward force enables a snug fit of the cup apparatus onto the base or lower portion of the water container or bottle. In one aspect of an embodiment of the present invention, the inward force may be exerted as a normal (i.e. perpendicular direction) from the surface of the rib(s) onto the surface of the container.

### BRIEF DESCRIPTION OF THE DRAWING(S)

FIG. 1 illustrates a top perspective view of a cup apparatus according to an aspect of an embodiment of the present invention.

FIG. 2 illustrates a bottom perspective view of a cup apparatus according to an aspect of an embodiment of the present invention.

FIG. 3 illustrates a top view of a cup apparatus according to an aspect of an embodiment of the present invention.

FIG. 4 illustrates a bottom view of a cup apparatus according to an aspect of an embodiment of the present invention.

FIG. 5 illustrates a side view of a cup apparatus according to an aspect of an embodiment of the present invention.

FIG. 6 illustrates perspective views of cup apparatuses being used in conjunction with different bottles according to aspects of embodiments of the present invention.

### DETAILED DESCRIPTION OF THE INVENTION

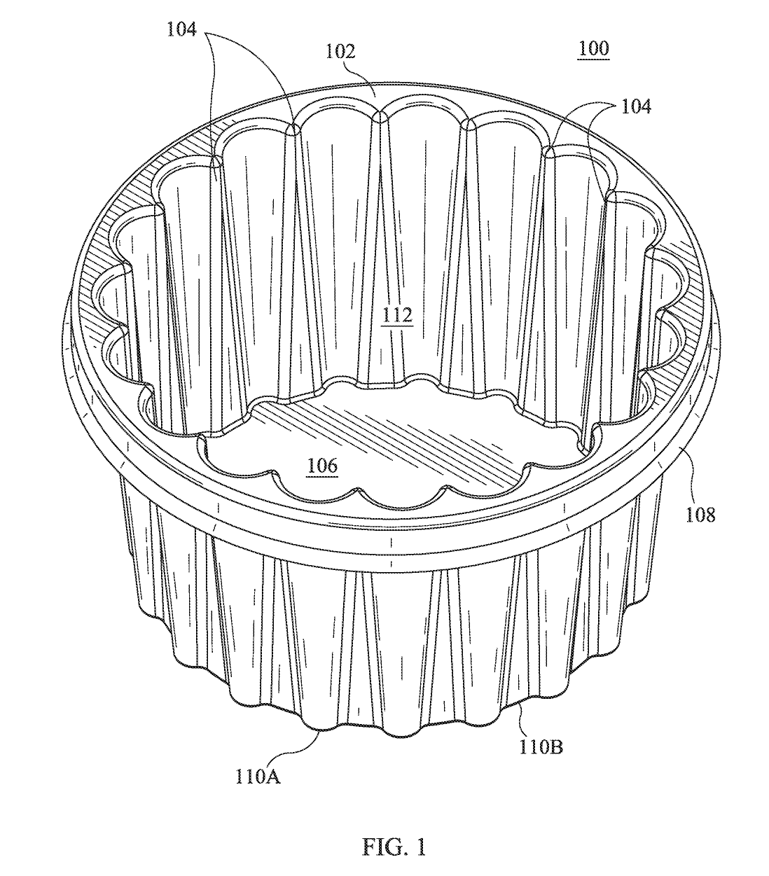

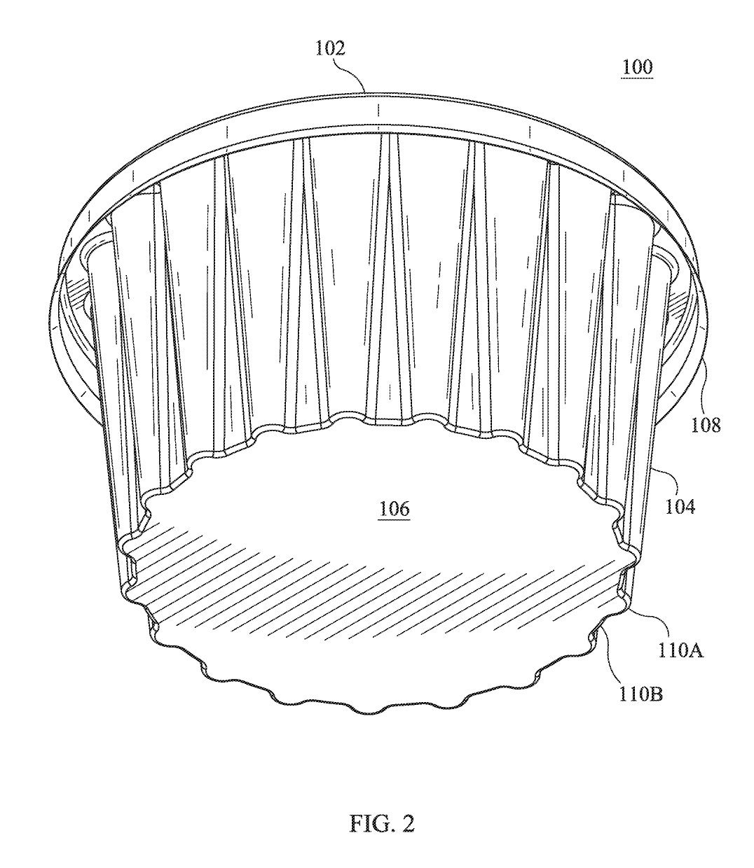

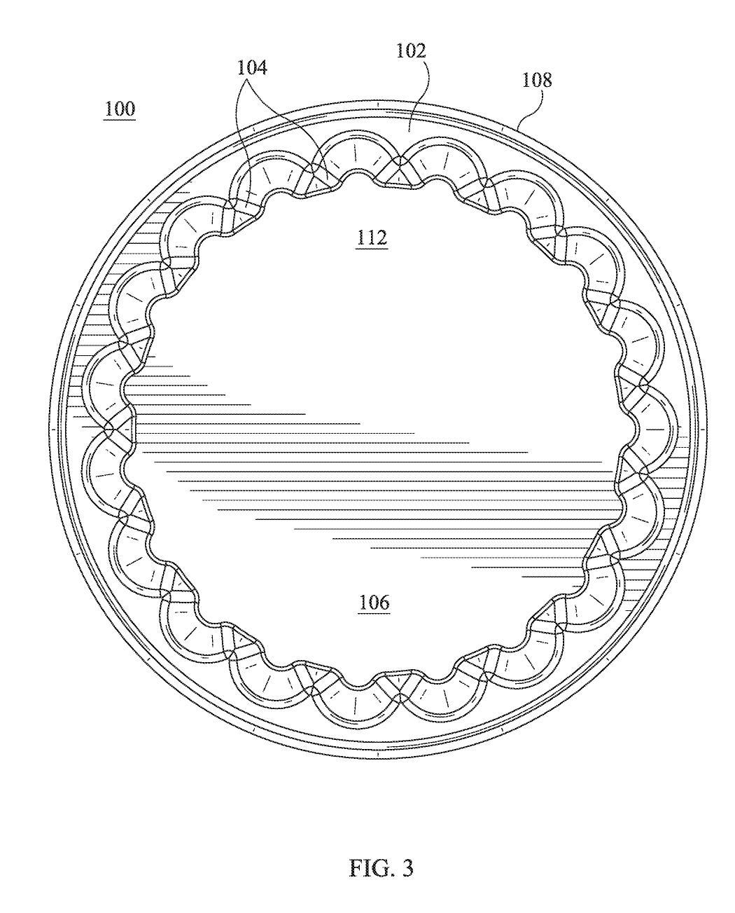

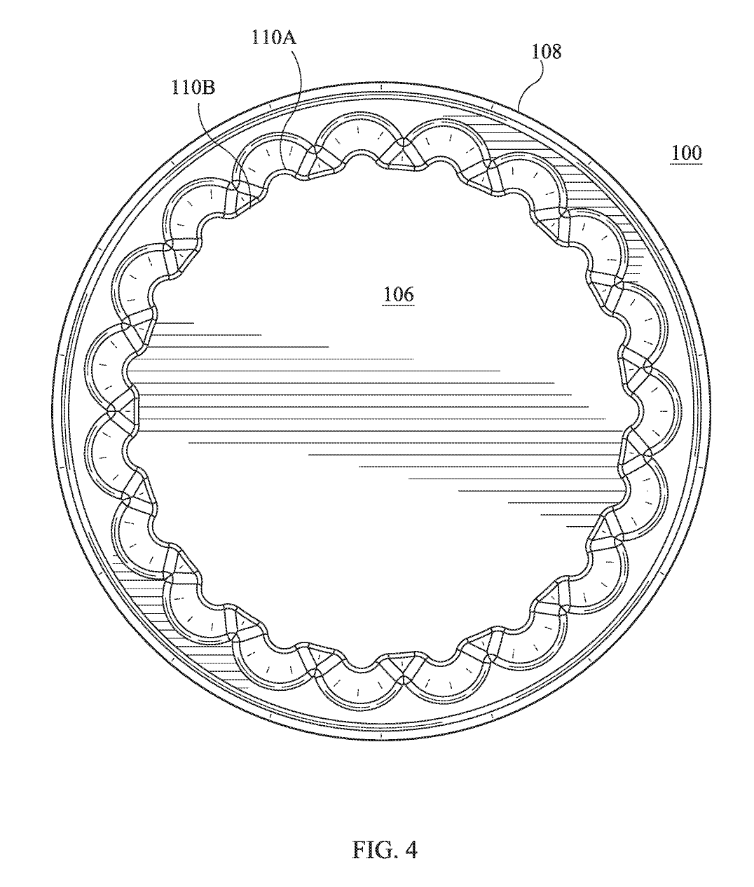

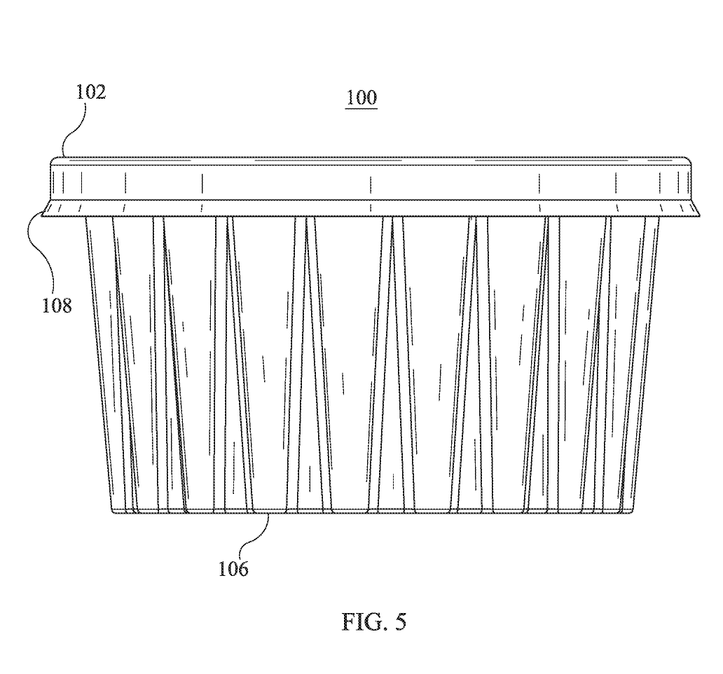

Referring now to FIGS. 1 through 5, a cup apparatus 100 is shown according to aspects of embodiments of the present invention. Cup apparatus 100 is shown with a top portion or mouth 102 circumferentially positioned at the top of the apparatus. Connected to top portion or mouth 102 are the tops of a plurality of ribs 104 extending downward and connecting, at their respective bases, with base 106 of cup apparatus 100. In an aspect of an embodiment of the present invention, cup apparatus 100 may include lip 108 which is circumferentially connected with top portion or mouth 102. Top portion or mouth 102, ribs 104 and base 106 form enclosure 112, within which a user may removably place a bottle or container.

In an aspect of an embodiment of the present invention, the connection between ribs 104 and base 106 may be characterized by a portion 110A, which is not bulged, and bulged portion 110B. In another aspect of an embodiment of the present invention, the base connection of ribs 104 may form a smooth circular base without bulges 110B.

In an aspect of an embodiment of the present invention, ribs 104 may include bulges (not shown) positioned at any point between top portion or mouth 102 and base 106, that extend toward the center of enclosure 112. These bulges serve to provide perpendicular forces that act on the surface of a user's bottles to ensure a snug fit of cup apparatus 100 onto a bottle or container.

In an aspect of an embodiment of the present invention, the area circumferentially formed by top portion or mouth 102 may be less than the area of base 106. As such, top portion or mouth 102 would then serve to provide the snug fit of cup apparatus 100 onto the base of the container. In instances where top portion or mouth 102 and base 106 are circular in shape, this may be possible by top portion or mouth 102 having a smaller radius than radius of base 106.

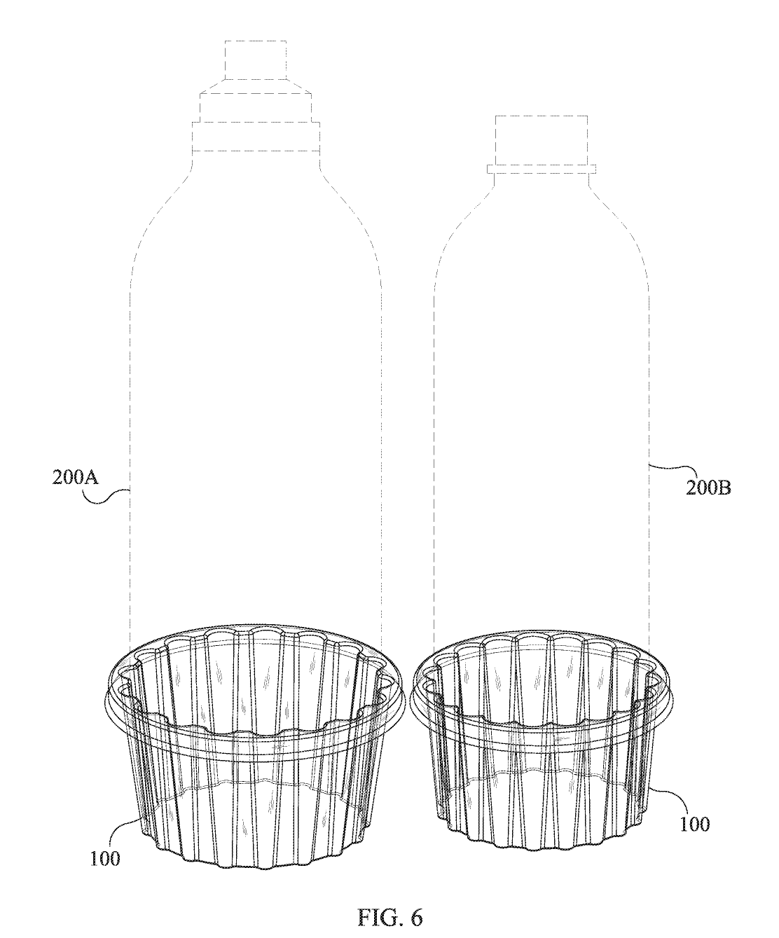

Referring now to FIG. 6, perspective views of cup apparatuses 100 being used in conjunction with different bottles 200A and 200B are shown according to aspects of embodiments of the present invention. Here, each cup apparatus 100 is each respectively and removably attached to the base of each container 200A, 200B. A snug fit in ensured by action of plurality of ribs 104 being in contact with the surface of containers 200A and 200B.

In an aspect of an embodiment of the present invention, one or more of plurality of ribs 104 may include one or more bulge(s) (not shown) which may extend perpendicularly from the rib and towards the center of enclosure 112. These bulge(s) may, in one aspect of an embodiment of the present invention, be positioned at a spot on the respective rib(s) 104 between top 102 and base 106. In another aspect of an embodiment of the present invention, the bulge(s) may, by way of them extending from their respective rib(s) 104, may be closer to enclosure 112's center more than top 102 and/or base 106. The bulge(s) may enable a tighter or more snug fit of cup apparatus 100 with the base of container 200A or 200B.

The invention has been described in detail with particular reference to certain preferred embodiments thereof, but it will be understood that variations and modifications can be implemented within the spirit and scope of the invention.

What is claimed is:

1. A cup apparatus comprising:
a mouth;
a plurality of ribs, extending downwardly from the mouth of the apparatus;
a base, in contact with the downwardly extending plurality of ribs, wherein the plurality of ribs connect the mouth with the base; and
a lip around the mouth of the apparatus, wherein the tops of the plurality of ribs contact the lip's base.

2. The cup apparatus of claim 1 wherein the mouth of the apparatus has a smaller radius than that of the base.

3. The cup apparatus of claim 1 wherein the plurality of ribs are interconnected with each other.

4. The cup apparatus of claim 1 wherein the plurality of ribs are structurally configured to exert inward force at least one point midway between the mouth and base of the apparatus.

5. The cup apparatus of claim 4, wherein the inward force is enabled by at least one bulge on at least one of the plurality of ribs.

6. The cup apparatus, further comprising an enclosure, wherein the enclosure is formed or bordered by the mouth, plurality of ribs and the base.

7. The cup apparatus of claim 6, wherein at least one of the plurality of ribs comprises of at least one bulge positioned one the at least one of the plurality of ribs at a position between the mouth and the base, wherein the at least one bulge extends towards the enclosure's center.

8. The cup apparatus of claim 7 wherein the bulge is closer to the enclosure's center than any other point on the at least one of the plurality of ribs.

9. The cup apparatus of claim 1, wherein the plurality of ribs are expandable.
